(19) United States
(12) Patent Application Publication
(10) Pub. No.: US 2024/0377633 A1
(43) Pub. Date: Nov. 14, 2024

(54) IMAGE GENERATION APPARATUS AND HEAD-UP DISPLAY

(71) Applicant: KOITO MANUFACTURING CO., LTD., Tokyo (JP)

(72) Inventor: Yoshinori Sawa, Shizuoka (JP)

(73) Assignee: KOITO MANUFACTURING CO., LTD., Tokyo (JP)

(21) Appl. No.: 18/691,099

(22) PCT Filed: Aug. 22, 2022
(86) PCT No.: PCT/JP2022/031505

§ 371 Date: Mar. 12, 2024

(30) Foreign Application Priority Data
Sep. 15, 2021 (JP) 2021-150464

(51) Int. Cl. G02B 27/01

(52) U.S. Cl. CPC G02B 27/0101

(57) ABSTRACT

An image generation apparatus includes a light source unit, a light guide plate that emits light emitted from the light source unit in a predetermined direction, a liquid crystal device that generates an image by light emitted from the light guide plate, and a housing having a heat dissipation function. The light source unit and the liquid crystal device are attached to the housing.

### TECHNICAL FIELD

The present disclosure relates to an image generation apparatus and a head-up display including the image generation apparatus.

### BACKGROUND ART

Patent Literature 1 discloses an image generation apparatus for a head-up display (HUD). Light for generating an image emitted from the image generation apparatus is reflected by a reflector and projected onto a windshield of a vehicle. Part of the light projected onto the windshield is reflected by the windshield and directed toward eyes of a driver. The driver perceives the reflected light entering the eyes against the background of a real object seen through the windshield, as a virtual image that looks like an image of an object on an opposite side (outside of the vehicle) with the windshield interposed therebetween.

The image generation apparatus includes a light source, a lens that transmits light emitted from the light source, and a liquid crystal device that emits light for generating an image by the light having transmitted through the lens.

### CITATION LIST

### Patent Literature

Patent Literature 1: JP2011-165624A

### SUMMARY OF INVENTION

### Technical Problem

In the above image generation apparatus, the light source, the lens, and the liquid crystal device are supported by the housing along a light irradiation direction of the light source, and a light path from the light source to a liquid crystal panel is configured to be linear. In addition, in order to dissipate heat generated from the light source, a heat sink is provided on a back side of a substrate on which the light source is mounted.

The present disclosure is to provide an image generation apparatus and a head-up display that can suppress an increase in the number of components and an increase in the size of the apparatus while dissipating heat generated from a light source.

### Solution to Problem

An image generation apparatus according to a first aspect of the present disclosure includes:
a light source unit;
an optical member configured to emit light emitted from the light source unit in a predetermined direction;
a liquid crystal device configured to generate an image by the light emitted from the optical member; and
a housing having a heat dissipation function,
wherein the light source unit and the liquid crystal device are attached to the housing.

A head-up display according to a second aspect of the present disclosure includes:
the image generation apparatus of the first aspect; and
at least one reflector configured to reflect light emitted by the image generation apparatus.

### Advantageous Effects of Invention

According to the present disclosure, it is possible to suppress an increase in the number of components and an increase in the size of the apparatus while dissipating heat generated from the light source.

### BRIEF DESCRIPTION OF DRAWINGS

FIG. 1 is a schematic diagram showing a configuration of a head-up display (HUD) according to an embodiment.

FIG. 2 is a perspective view showing a configuration of an image generation apparatus according to an embodiment.

FIG. 3 is a perspective view showing a configuration of the image generation apparatus according to the embodiment.

FIG. 4 is a schematic cross-sectional view taken along an IV-IV line in FIG. 3.

### DESCRIPTION OF EMBODIMENTS

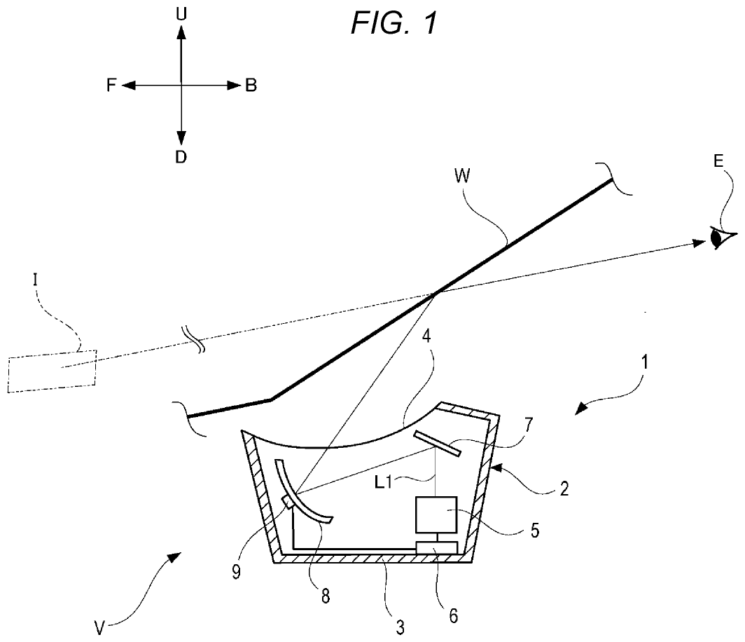

Hereinafter, embodiments of the present invention will be described with reference to the drawings. For convenience of description, the dimension of each member shown in the drawings may be different from the dimension of each actual member. In addition, in the drawings, an arrow U indicates an up direction in the shown structure. An arrow D indicates a down direction in the shown structure. An arrow F indicates a front direction in the shown structure. An arrow B indicates a back direction in the shown structure. An arrow R indicates a right direction in the shown structure. An arrow L indicates a left direction in the shown structure. These directions are relative directions set with respect to a head-up display (HUD) 1 shown in FIG. 1.

FIG. 1 is a schematic view of a HUD 1 according to an embodiment, as seen from a side of a vehicle V. The HUD 1 is provided in the vehicle V. For example, the HUD 1 is arranged in a dashboard of the vehicle V.

The HUD 1 serves as a visual interface between the vehicle V and an occupant of the vehicle V. Specifically, the HUD is configured to display predetermined information as a predetermined image so that the predetermined information is superimposed on a real space outside the vehicle V (in particular, a surrounding environment ahead of the vehicle V). The predetermined image may include a still image or a moving image (video). The information that is displayed by the HUD 1 is, for example, vehicle driving information related to driving of the vehicle V and/or surrounding environment information related to a surrounding environment of the vehicle V (in particular, information related to target objects existing outside of the vehicle V), and the like.

As shown in FIG. 1, the HUD 1 includes a HUD main body part 2. The HUD main body part 2 includes a housing 3 and an emission window 4. The emission window 4 is composed of a transparent plate that transmits visible light. The HUD main body part 2 includes an image generation apparatus (PGU) 5, a controller 6, a plane mirror 7, and a concave mirror 8 inside of the housing 3. The plane mirror 7 and the concave mirror 8 are examples of the reflector.

The image generation apparatus 5 is configured to emit light for generating a predetermined image. The image generation apparatus 5 is fixed to the housing 3. The light emitted from the image generation apparatus 5 is, for example, visible light.

The controller 6 controls an operation of each unit of the HUD 1. The controller 6 is connected to a vehicle controller (not shown) of the vehicle V. For example, the controller 6 generates a control signal for controlling an operation of the image generation apparatus 5 based on the vehicle driving information, the surrounding environment information, and the like transmitted from the vehicle controller, and transmits the generated control signal to the image generation apparatus 5. The controller 6 is equipped with a processor such as a CPU (Central Processing Unit) and a memory, and the processor executes a computer program read out from the memory to control operations of the image generation apparatus 5 and the like.

The plane mirror 7 is arranged on a light path of the light emitted from the image generation apparatus 5. Specifically, the plane mirror 7 is arranged above the image generation apparatus 5 and is configured to reflect the light emitted from the image generation apparatus 5 toward the concave mirror 8. The plane mirror 7 has a planar reflective surface and reflects an image of light emitted from the image generation apparatus 5 and formed into an image at the same magnification.

The concave mirror 8 is arranged on a light path of the light emitted from the image generation apparatus 5 and reflected by the plane mirror 7. Specifically, the concave mirror 8 is arranged in front of the image generation apparatus 5 and the plane mirror 7 in the housing 3. The concave mirror 8 is configured to reflect the light emitted from the image generation apparatus 5 toward a windshield W (for example, a front window of the vehicle V). The concave mirror 8 has a reflective surface curved in a concave shape. The concave mirror 8 reflects an image of the light emitted from the image generation apparatus 5 and formed into an image at a predetermined magnification. The concave mirror 8 may be configured to be rotatable by a driving mechanism 9.

As shown in FIG. 1, light LI emitted from the image generation apparatus 5 is reflected by the plane mirror 7 and the concave mirror 8 and emitted from the emission window 4 of the HUD main body part 2. The light emitted from the emission window 4 of the HUD main body part 2 is irradiated to the windshield W. Part of the light irradiated to the windshield W from the emission window 4 is reflected toward a viewpoint E of the occupant. As a result, the occupant recognizes the light emitted from the HUD main body part 2 as a virtual image (predetermined image) formed at a predetermined distance ahead of the windshield W. In this way, the image displayed by the HUD 1 is superimposed on a real space ahead of the vehicle V through the windshield W, so that the occupant can visually recognize a virtual image object I formed by the predetermined image as if it is floating on the road located outside of the vehicle.

When forming a 2D image (plane image) as the virtual image object I, the predetermined image is projected so as to be a virtual image at a single distance arbitrarily determined. When forming a 3D image (stereoscopic image) as the virtual image object I, a plurality of predetermined images that are the same or different from each other are projected so as to be virtual images at different distances, respectively. The distance of the virtual image object I (a distance from the viewpoint E of the occupant to the virtual image) can be adjusted appropriately by adjusting a distance from the image generation apparatus 5 to the viewpoint E of the occupant (for example, by adjusting a length of a light path between the image generation apparatus 5 and the concave mirror 8).

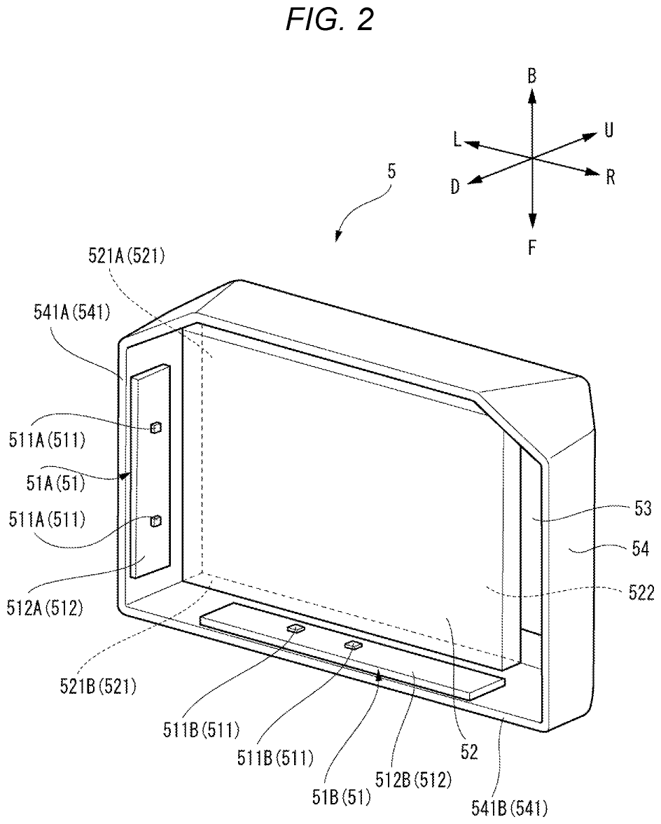

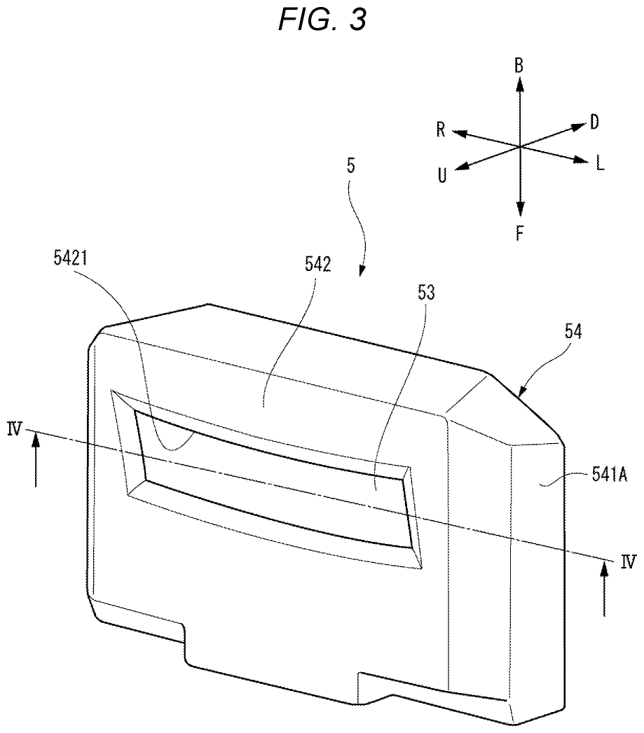

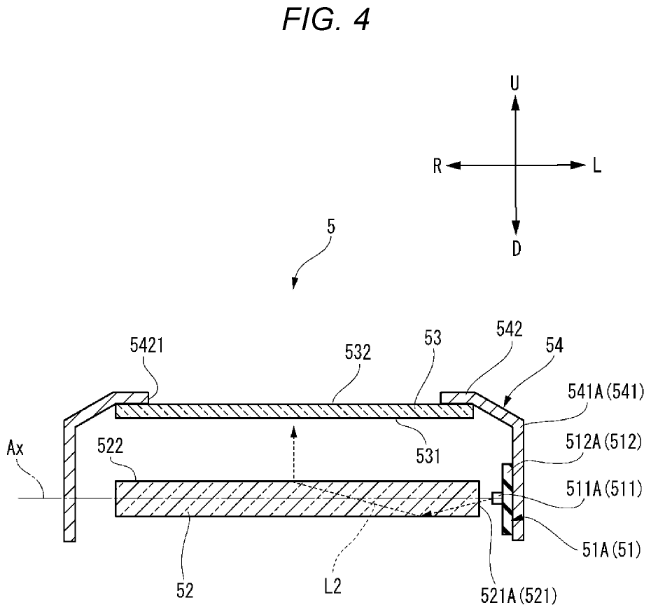

Next, a configuration of the image generation apparatus 5 will be described using FIGS. 2 to 4. FIGS. 2 and 3 are perspective views showing a configuration example of the image production apparatus 5. FIG. 4 is a schematic cross-sectional view of the image generation apparatus 5, and shows a light path of light L2 emitted from a light source 511.

As shown in FIG. 2, the image generation apparatus 5 includes a light source unit 51, a light guide plate 52, a liquid crystal device 53, and a housing 54. The light guide plate 52 is an example of the optical member.

The light source unit 51 includes a light source 511 and a substrate 512. The light source 511 is, for example, an LED light source or a laser light source. The LED light source is, for example, a white LED light source. The laser light source is, for example, an RGB laser light source configured to emit red laser light, green laser light, and blue laser light, respectively. The light source 511 is mounted on the substrate 512. The substrate 512 is, for example, a printed board made of an insulator with an electrical circuit wiring printed on its surface or inside. The substrate 512 is attached to the housing 54.

In the present embodiment, the image generation apparatus 5 includes two light source units 51A and 51B. The light source unit 51A includes two light sources 511A and a substrate 512A. The light source unit 51B includes two light sources 511B and a substrate 512B. Note that the number of the light sources 511 included in the light source unit 51 is not limited to two. For example, the light source unit 51 may include three or more light sources 511.

The light guide plate 52 is formed of a transparent material such as glass or plastic, for example. As shown in FIG. 4, the light guide plate 52 is configured to emit light emitted from the light source 511 in a direction orthogonal to an optical axis Ax of the light source 511. The direction orthogonal to the optical axis Ax of the light source 511 is an example of the direction intersecting with the optical axis Ax of the light source 511. The expression “optical axis of the light source 511” used in the present specification means a line of light with the highest luminance among the lights emitted from the light source 511. For example, when the light source 511 is an LED light source, an optical axis of the LED light source means a straight line that passes through a center with the highest luminance of a light emitting surface of the LED light source and is parallel to the normal line of the light emitting surface.

The light guide plate 52 has an incident surface 521 and an emission surface 522. The light emitted from the light source 511 is incident on the incident surface 521. The emission surface 522 is configured to intersect with the incident surface 521. The emission surface 522 emits the light incident on the incident surface 521 and reflected within the light guide plate 52 toward the liquid crystal device 53.

In the present embodiment, the light guide plate 52 is a plate-shaped member, the liquid crystal device 53 is arranged above the light guide plate 52, and the light source units 51A and 51B are arranged on sides of the light guide plate 52. The light guide plate 52 has two incident surfaces 521A and 521B, in which the incident surface 521A faces the light source unit 51A and the incident surface 521B faces the light source unit 51B. The emission surface 522 is orthogonal to the incident face 521A and the incident face 521B, respectively, and faces the liquid crystal device 53.

As shown in FIG. 4, light L2 emitted from the light source 511A is incident on the incident surface 521A of the light guide plate 52 and travels within the light guide plate 52 while being reflected. Then, the light L2 is emitted from the emission surface 522 of the light guide plate 52. Similarly, light (not shown) emitted from the light source 511B is incident on the incident surface 521B of the light guide plate 52, travels within the light guide plate 52 while being reflected, and is emitted from the emission surface 522.

The liquid crystal device 53 is configured to generate a predetermined image by light emitted from the light guide plate 52. The liquid crystal device 53 is, for example, a liquid crystal monitor (LCD). The liquid crystal device 53 has an incident surface 531 and an emission surface 532. The incident surface 531 faces the emission surface 522 of the light guide plate 52. Light emitted from the light guide plate 52 is incident on the incident surface 531. Light for generating a predetermined image is emitted from the emission surface 532.

The housing 54 has a heat dissipation function. The housing 54 is formed of, for example, metal such as aluminum or resin with high thermal conductivity. The housing 54 is made of a single member and has a monolithic structure. For example, the housing 54 is formed integrally by so-called aluminum die-casting in which aluminum is cast and molded using a mold.

The light source unit 51, the light guide plate 52, and the liquid crystal device 53 are attached to the housing 54. The light source unit 51 is attached to the housing 54 so as not to face the incident surface 531 of the liquid crystal device 53. Furthermore, the light source unit 51 is attached to the housing 54 so as not to overlap the liquid crystal device 53 in a plan view of the liquid crystal device 53 (when seen from above in FIG. 4).

Specifically, the substrate 512 of the light source unit 51 is attached to a side surface part 541 of the housing 54, and the liquid crystal device 53 is attached to an upper surface part 542 of the housing 54. In the present embodiment, the substrate 512A of the light source unit 51A is attached to a side surface part 541A of the housing 54, and the substrate 512B of the light source unit 51B is attached to a side surface part 541B of the housing 54. The liquid crystal device 53 is covered by the upper surface part 542 of the housing 54 from the emission surface 532 side, and a part of the liquid crystal device 53 is exposed through an opening 5421 formed in the upper surface part 542. The emitted light for generating a predetermined image is emitted upward from the emission surface 532 through the opening 5421.

As described above, according to the image generation apparatus 5 of the present embodiment, the light source unit 51 and the liquid crystal device 53 are provided to the common housing 54 having a heat dissipation function, and the heat generated from the light source unit 51 and the liquid crystal device 53 is dissipated by the common housing 54. That is, the heat generated from the liquid crystal device 53 is transferred to the housing 54 and is dissipated from the housing 54. Additionally, the heat generated from the light source 511 is transferred to the housing 54 via the substrate 512 and is dissipated by the housing 54. Therefore, there is no need to provide separate heat dissipation members for the light source unit 51 and the liquid crystal device 53. For example, it is not necessary to provide a heat sink on a back side of the substrate 512 in order to dissipate the heat generated from the light source 511. This can suppress an increase in the number of components and an increase in the size of the apparatus.

The light emitted from the light source 511 is emitted by the light guide plate 52 in the direction intersecting with the optical axis Ax of the light source 511. As a result, it is not necessary to arrange the liquid crystal device 53 in the light emission direction of the light source 511 in order to cause the light emitted from the light source 511 to be incident on the liquid crystal device 53. Therefore, it is possible to suppress the image generation apparatus 5 from increasing in size in a depth direction (up-down direction in FIG. 4).

The light source unit 51 and the incident surface 531 of the liquid crystal device 53 do not face each other, and do not overlap the liquid crystal device 53 in a plan view of the liquid crystal device 53. That is, since the liquid crystal device 53 is not arranged in the light emission direction of the light source 511, it is possible to suppress the image generation apparatus 5 from increasing in size in the depth direction (up-down direction in FIG. 4).

In addition, since the light emitted from the light source 511 is emitted to the liquid crystal device 53 using one light guide plate 52, an increase in the number of components can be suppressed compared to a configuration in which a plurality of optical members are combined.

Although the embodiment of the present invention has been described, it should be noted that the technical scope of the present Invention should not be construed as being limited by the description of the present embodiment. It is understood by one skilled in the art that the present embodiment is just an example and the embodiment can be variously changed within the scope of the invention described in the claims. The technical scope of the present invention should be determined based on the scope of the invention described in the claims and the equivalent scope thereof.

The substrate 512 may be attached to the housing 54 via another member. For example, the substrate 512 may be attached to the housing 54 via a heat conducting member. The liquid crystal device 53 may be attached to the housing 54 via another member. For example, the liquid crystal device 53 may be attached to the housing 54 via a heat conducting member.

The substrate 512 may be a flexible substrate. In this case, the substrate 512 can be attached while deforming the substrate in conformity to a shape of the housing 54.

As an example of the optical member, the light guide plate 52 has been described. However, the optical member may also be composed of a half mirror, a prism, or the like.

The image generation apparatus 5 includes two light source units 51. However, the image generation apparatus 5 may include only one light source unit 51 or may include three or more light source units 51.

The light emitted from the image generation apparatus 5 is reflected by the concave mirror 8 and irradiated to the windshield W. However, the present invention is not limited thereto. For example, the light reflected by the concave mirror 8 may be irradiated to a combiner (not shown) provided on an inner side of the windshield W. The combiner is composed of, for example, a transparent plastic disc. Part of the light irradiated to the combiner from the image generation apparatus 5 of the HUD main body part 2 is reflected toward the viewpoint E of the occupant, similar to the case where the light is irradiated to the windshield W.

The present application is based on Japanese Patent Application No. 2021-150464 filed on Sep. 15, 2021, the contents of which are incorporated herein by reference.

1. An image generation apparatus comprising:
a light source unit;
an optical member configured to emit light emitted from the light source unit in a predetermined direction;
a liquid crystal device configured to generate an image by the light emitted from the optical member; and
a housing having a heat dissipation function,
wherein the light source unit and the liquid crystal device are attached to the housing.

2. The image generation apparatus according to claim 1, wherein the light source unit comprises a light source and a substrate on which the light source is mounted, and wherein the substrate is attached to the housing.

3. The image generation apparatus according to claim 1, wherein the optical member is configured to emit the light emitted from the light source unit in a direction intersecting with an optical axis of the light source unit.

4. The image generation apparatus according to claim 3, wherein the optical member is a light guide plate, and wherein the light guide plate has an incident surface on which the light emitted from the light source unit is incident and an emission surface intersecting with the incident surface and configured to emit light toward the liquid crystal device.

5. The image generation apparatus according to claim 1, wherein the liquid crystal device has an incident surface on which the light emitted from the optical member is incident, and
wherein the light source unit is attached to the housing so as not to face the incident surface of the liquid crystal device.

6. The image generation apparatus according to claim 1, wherein the light source unit is attached to the housing so as not to overlap the liquid crystal device in a plan view of the liquid crystal device.

7. A head-up display comprising:
an image generation apparatus comprising:
a light source unit;
an optical member configured to emit light emitted from the light source unit in a predetermined direction;
a liquid crystal device configured to generate an image by the light emitted from the optical member; and
a housing having a heat dissipation function,
wherein the light source unit and the liquid crystal device are attached to the housing; and
at least one reflector configured to reflect light emitted by the image generation apparatus.
